(19) United States
(12) Patent Application Publication
(10) Pub. No.: US 2003/0072333 A1
(43) Pub. Date: Apr. 17, 2003

(54) NRZ to RZ conversion in mode-locked laser using wavelength locked loops

(75) Inventors: Lawrence Jacobowitz, Wappingers Falls, NY (US); Casimer M. DeCusatis, Poughkeepsie, NY (US)

Correspondence Address: Steven Fischman, Esq., Scully, Scott, Murphy & Presser, 400 Garden City Plaza, Garden City, NY, 11530, US

(73) Assignee: INTERNATIONAL BUSINESS MACHINES CORPORATION, Armonk, NY

(21) Appl. No.: 09/975,266

(22) Filed: Oct. 11, 2001

(51) Int. Cl. H01S 3/10

(52) U.S. Cl. 372/20

(57) ABSTRACT

An NRZ to RZ conversion arrangement with a mode-locked laser, a wavelength locked feedback loop, and a disk shaped variable optical density filter wheel having a plurality of different filter components, filter 1, filter 2, filter 3, . . . filter n circumferentially spaced therearound. The disk filter wheel is driven to rotate about its central axis by a motor, with the filter being positioned in an external laser cavity having the laser and an external cavity mirror with diffraction grating rulings, which forms a frequency mode selective component. The disk filter is positioned parallel to the external cavity mirror, and by rotating the disk filter the wavelength of the mode locked laser is selectively tuned. The wavelength locked control loop allows greater precision in tuning the wavelength of the mode locked laser, or/and adjusting the rotation speed of the filter wheel, providing the ability to dynamically adjust for variations in the filter disk rotation speed, or aging of any system component, or temperature variations. This level of control makes RZ modulation a more practical and lower cost alternative, as well as facilitating the use of mode locked lasers for RZ to NRZ conversions.

### BACKGROUND OF THE INVENTION

1. Field of the Invention

The present invention relates generally to NRZ to RZ conversions in mode-locked lasers using wavelength locked feedback loops. The wavelength locked control loop allows greater precision in tuning the wavelength of a mode locked laser diode, providing the ability to dynamically adjust for variations in the NRZ to RZ conversion circuit, or laser aging effects in the laser or any system component, or temperature variations. This level of control makes RZ modulation a more practical and lower cost alternative, as well as facilitating the use of mode locked lasers for RZ to NRZ conversions.

2. Discussion of the Prior Art

FIGS. 1a and 1b illustrate different signal formats for representing a binary message. FIG. 1a illustrates unipolar waveforms for RZ and NRZ formats, while FIG. 1b illustrates polar waveforms for RZ and NRZ formats.

The waveforms at the top of FIG. 1a are for an RZ format signal which represents each 0 by an off pulse and each 1 by an on pulse with duration D/2, followed by a return to the zero level (the format is called return to zero because the light is turned off between successive pulses, whether a 0 or a 1). This is commonly known as a return to zero (RZ) format. The unipolar nature of this type of on-off signal results in a DC component that carries no information and wastes power.

The waveforms at the top of FIG. 1b are for an RZ format signal which illustrates a polar form of RZ which is often used. The DC component of this signal will average to zero as long as there are equal numbers of 1 and 0 symbols in the message. It can be shown that the received signal power for the polar waveform is larger than for the unipolar case by a factor of the square root of 2, and that the signal to noise ratio for the polar case is twice that of the unipolar case.

By contrast, a non-return to zero (NRZ) format signal, shown at the bottoms of FIGS. 1a and 1b, has on-pulses for the full bit duration. This format puts more energy into each pulse, but requires synchronization of the bit stream at the receiver because there is no separation between adjacent pulses. Digital computer waveforms are usually of this type.

The future of large capacity wavelength division multiplexing (WDM) systems depends in part on implementing effective signal modulation techniques. ATM switches, SONET equipment, and most routers use a simpler nonreturn-to-zero (NRZ) signal format in wide area networks. This is a simple on/off signal format in which light on indicates a logic 1 and light off indicates a logic 0. By contrast, soliton-based long haul optical communication systems such as the proposed 40 Gbit/s standards and submarine transmission cables use return to zero (RZ) encoding. In this signal format, a logic 1 is indicated by a pulse of light and a logic 0 is indicated by absence of a pulse (the format is called return to zero because the light is turned off between successive pulses).

RZ modulation offers several advantages: while the bandwidth of an RZ signal is higher, leading to increased chromatic dispersion, RZ signals offer better immunity to nonlinear fiber effects and polarization mode dispersion (PMD). In general, nonlinear effects are harder to compensate for than linear ones, hence in a high performance system RZ encoding offers better overall performance. Multiple RZ data streams can also be time division multiplexed together for improved management of the available fiber bandwidth.

Networking devices for WDM need to operate either within the same signal format as the subtended equipment, or need to convert efficiently between different signal formats, such as from NRZ to RZ signal formats. Since RZ modulation requires the light to completely turn off between pulses, it can be practically implemented only with external cavity modulators; these external cavity modulators are the devices of choice for both RZ and NRZ to RZ conversion schemes. Because mode locking of lasers can also be achieved with external cavity modulators, and produces good high speed modulation characteristics, this has led to research in RZ transmission systems for mode-locked laser diodes. External cavity modulation also offers the advantage of being able to increase the peak optical power as the laser pulse width is decreased, thereby providing a constant average power level launched into the fiber link. Various schemes have been proposed, including diffraction gratings coupled to Fabry-Perot filters and micro-electro-mechanical devices (MEMs). However, such approaches require the grating or filter to tilt about an axis parallel to the grating rulings for tunability, which disadvantageously requires physical space in the laser/grating packaging arrangement.

The explanations herein discuss both wavelength and frequency, which have a reciprocal relationship (λ=c/f, where c=speed of light), as is well known in the field of optics.

Wavelength Division Multiplexing (WDM) and Dense Wavelength Division Multiplexing (DWDM) are light-wave application technologies that enable multiple wavelengths (colors of light) to be paralleled into the same optical fiber with each wavelength potentially assigned its own data diagnostics. Currently, WDM and DWDM products combine many different data links over a single pair of optical fibers by re-modulating the data onto a set of lasers, which are tuned to a very specific wavelength (within 0.8 nm tolerance, following industry standards). On current products, up to 32 wavelengths of light can be combined over a single fiber link with more wavelengths contemplated for future applications. The wavelengths are combined by passing light through a series of thin film interference filters, which consist of multilayer coatings on a glass substrate, pigtailed with optical fibers. The filters combine multiple wavelengths into a single fiber path, and also separate them again at the far end of the multiplexed link. Filters may also be used at intermediate points to add or drop wavelength channels from the optical network.

Ideally, a WDM laser would produce a very narrow linewidth spectrum consisting of only a single wavelength, and an ideal filter would have a square bandpass characteristic of about 0.4 nm width, for example, in the frequency domain. In practice, however, every laser has a finite spectral width, which is a Gaussian spread about 1 to 3 nm wide, for example, and all real filters have a Gaussian bandpass function. It is therefore desirable to align the laser center wavelength with the center of the filter passband to facilitate the reduction of crosstalk between wavelengths, since the spacing between WDM wavelengths are so narrow. In commercial systems used today, however, it is very difficult to perform this alignment—lasers and filters are made by different companies, and it is both difficult and expensive to craft precision tuned optical components. As a result, the systems in use today are far from optimal; optical losses in a WDM filter can be as high as 4 db due to misalignment with the laser center wavelength (the laser's optical power is lost if it cannot pass through the filter). This has a serious impact on optical link budgets and supported distances, especially since many filters must be cascaded together in series (up to 8 filters in current designs, possibly more in the future). If every filter was operating at its worst case condition (worst loss), it would not be possible to build a practical system. Furthermore, the laser center wavelengths drift with voltage, temperature, and aging over their lifetime, and the filter characteristics may also change with temperature and age. The laser center wavelength and filter bandwidth may also be polarization dependent. This problem places a fundamental limit on the design of future WDM networking systems.

A second, related problem results from the fact that direct current modulation of data onto a semiconductor laser diode causes two effects, which may induce rapid shifts in the center wavelength of the laser immediately after the onset of the laser pulse. These are (1) frequency chirp and (2) relaxation oscillations. Both effects are more pronounced at higher laser output powers and drive voltages, or at higher modulation bit rates. Not only can these effects cause laser center wavelengths to change rapidly and unpredictably, they also cause a broadening of the laser linewidth, which can be a source of loss when interacting with optical filters or may cause optical crosstalk. Avoiding these two effects requires either non-standard, expensive lasers, external modulators (which are lossy and add cost), or driving the laser at less than its maximum power capacity (which reduces the link budget and distance). Lowering the data modulation rate may also help, but is often not an option in multi-gigabit laser links.

It would thus be highly desirable to provide a stable, optimal alignment between a laser center wavelength and the center of a Gaussian bandpass filter in order to optimize power transmission through such fiber optic systems and reduce optical crosstalk interference in optical networks.

### SUMMARY OF THE INVENTION

Accordingly, it is a primary object of the present invention to provide NRZ to RZ conversions in mode-locked lasers using wavelength locked feedback loops.

The present invention concerns wavelength selective devices which encompass wavelength selective devices of all types including filters of all types including comb, filters, etalon filters and rotatable disc filters and wavelength selective gratings of all types including Bragg gratings and array waveguide gratings.

It is an object of the present invention to provide a servo-control wavelength-locked loop circuit that enables real time mutual alignment of an electromagnetic signal having a peaked spectrum function including a center wavelength and a wavelength selective device implementing a peaked passband function including a center wavelength, in a system employing electromagnetic waves.

It is another object of the present invention to provide a servo-control system and methodology for WDM and DWDM systems and applications that is designed to optimize power through multi-gigabit laser/optic systems.

It is a further object of the present invention to provide a wavelength-locked loop for an optical system that enables real time alignment and tracking of any spectral device that selects a wavelength, such as a Bragg grating, in optical fibers and waveguides, etc., for use in WDM systems.

It is yet another object of the present invention to provide a servo/feedback loop for an optical system, referred to as a “wavelength-locked loop,” that enables real time alignment of a laser with variable optical attenuators by offsetting an optical filter from a known transmission in optical fibers and waveguides, etc.

It is yet a further object of the present invention to provide a servo/feedback loop for an optical system, referred to as a “wavelength-locked loop,” that may be used in light polarization applications.

It is still another object of the present invention to provide a servo/feedback loop for an optical system, referred to as a “wavelength-locked loop,” that enables real time alignment and tracking of laser center wavelengths and filter passband center wavelengths in multi-gigabit laser/optical systems such that the optical loss of a WDM filter/laser combination is greatly reduced, thereby enabling significantly larger link budgets and longer supported distances.

It is yet still another object of the present invention to provide a servo/feedback loop for an optical system, referred to as a “wavelength-locked loop,” that enables real time alignment and tracking of laser center wavelengths and filter passband center wavelengths in multi-gigabit laser/optical systems such that lower cost lasers and filters may be used providing a significant cost reduction in the WDM equipment.

When employed in laser/optical networks, the system and method of the present invention may be used to tune laser diode devices, and/or compensate for any type of wavelength-selective element in the network, including wavelength selective filters, attenuators, and switches, in fiber Bragg gratings, ring resonators in optical amplifiers, external modulators such as acousto-optic tunable filters, or array waveguide gratings. This applies to many other optical components in the network as well (for example, optical amplifiers that may act as filters when operating in the nonlinear regime). Furthermore, the system and method of the invention may be used to implement less expensive devices for all of the above application areas.

Alternately, the system and method of the invention may be implemented to tune such devices for WDM and optical network applications, in real-time, during manufacture, e.g., tuning all lasers to a specific wavelength. This would significantly increase lot yields of laser devices which otherwise may be discarded as not meeting wavelength specifications as a result of manufacture process variations, for example.

The wavelength locked loop of the present invention enables a tighter control of wavelength, which allows an increased density of wavelength channels with less cross talk between channels in a wavelength multiplex system, which might typically include 32 or 64 channels or links. Pursuant to the present invention, each channel includes a separate wavelength locked loop which includes a separate source such as a laser and wavelength selective device such as a filter. Accordingly a wavelength multiplex system can include an array of 32 or 64 lasers and an array of 32 or 64 filters.

### BRIEF DESCRIPTION OF THE DRAWINGS

The foregoing objects and advantages of the present invention for NRZ to RZ conversions in mode-locked lasers using wavelength locked feedback loops may be more readily understood by one skilled in the art with reference being had to the following detailed description of several embodiments thereof, taken in conjunction with the accompanying drawings wherein like elements are designated by identical reference numerals throughout the several views, and in which:

FIGS. 1a and 1b illustrate different signal formats for representing a binary message, wherein FIG. 1a illustrates unipolar waveforms for RZ and NRZ formats, while FIG. 1b illustrates polar waveforms for RZ and NRZ formats.

FIG. 1c illustrates a first embodiment of an NRZ to RZ conversion arrangement in a mode-locked laser using a wavelength locked loop as shown in FIG. 1d.

FIG. 1d illustrates a plot of the motor drive voltage and the position of the filter wheel with time as the motor is driven to position the first filter F1 in series with the external laser cavity, and then position the second filter F2 in series with the external laser cavity, and then position the third filter F3 in series with the external laser cavity.

FIG. 1e illustrates a second embodiment wherein the filter wheel is rotated at a relatively constant rotational velocity, and a sampling circuit is implemented as part of the wavelength locked loop to sample the light intensity whenever the filter wheel passes a given point.

FIGS. 2(a)-2(c) are signal waveform diagrams depicting the relationship between laser optical power as a function of wavelength for three instances of optic laser signals;

FIGS. 3(a)-3(c) are signal waveform diagrams depicting the laser diode drive voltage dither modulation (a sinusoid) for each of the three waveform diagrams of FIGS. 2(a)-2(c);

FIGS. 4(a)-4(c) are signal waveform diagrams depicting the resulting feedback error signal output of the PIN diode for each of the three waveform diagrams of FIGS. 2(a)-2(c);

FIGS. 5(a)-5(c) are signal waveform diagrams depicting the cross product signal resulting from the mixing of the amplified feedback error with the original dither sinusoid;

FIGS. 6(a)-6(c) are signal waveform diagrams depicting the rectified output laser bias voltage signals which are fed back to adjust the laser current and center frequency;

FIG. 7 is a generalized circuit diagram depicting how dithering is implemented in the WLL system of the present invention;

FIG. 8 is a general block diagram depicting the underlying system architecture for employing an optional wavelength shifter in the wavelength-locked loop technique, and also an optical system employing two bandpass filters according to the present invention;

FIG. 9 is a signal waveform diagram depicting the relationship between laser optical power as a function of wavelength for the case of aligning a laser signal through a system including two bandpass filters in series, as depicted in FIG. 8;

### DETAILED DESCRIPTION OF THE DRAWINGS

The present invention provides a novel servo-control system implemented for optical systems including light sources, such as lasers, and frequency selective devices, such as bandpass filters. The servo-control system, herein referred to as the “wavelength-locked loop” or “lambda-locked loop” (since the symbol lambda is commonly used to denote wavelength), implements a dither modulation to continuously adjust an electromagnetic signal source characterized as having a peaked frequency spectrum or peaked center wavelength, e.g., laser light, so as to track the center of a frequency selective device, e.g. a filter passband. In this manner, optimal power of the signal is transmitted and optimal use is made of the system transmission bandwidth.

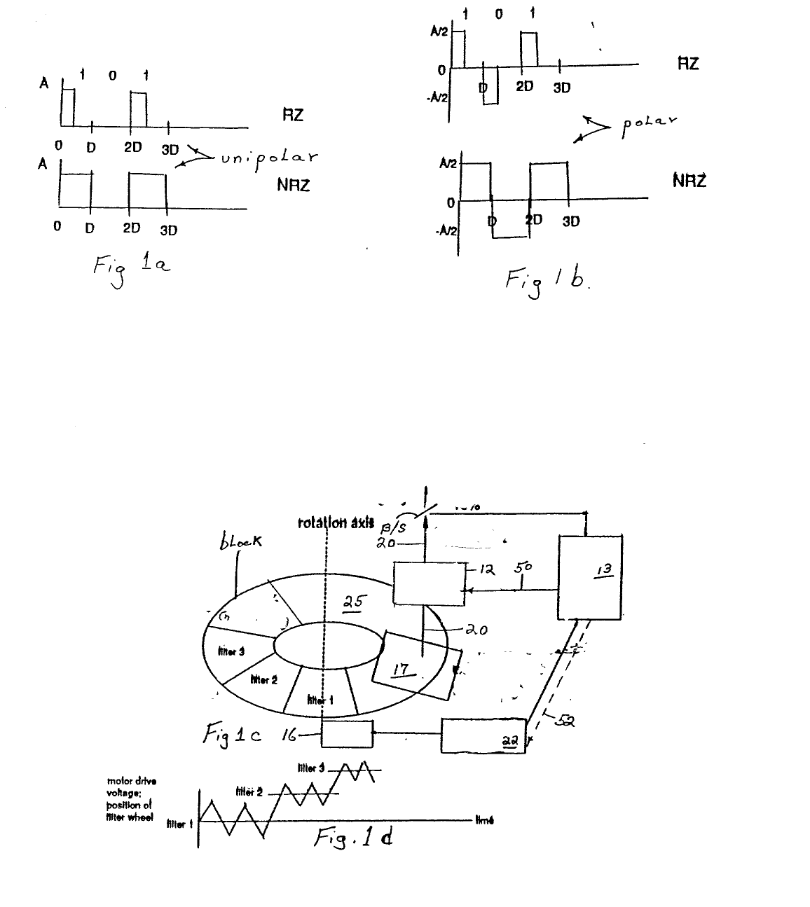

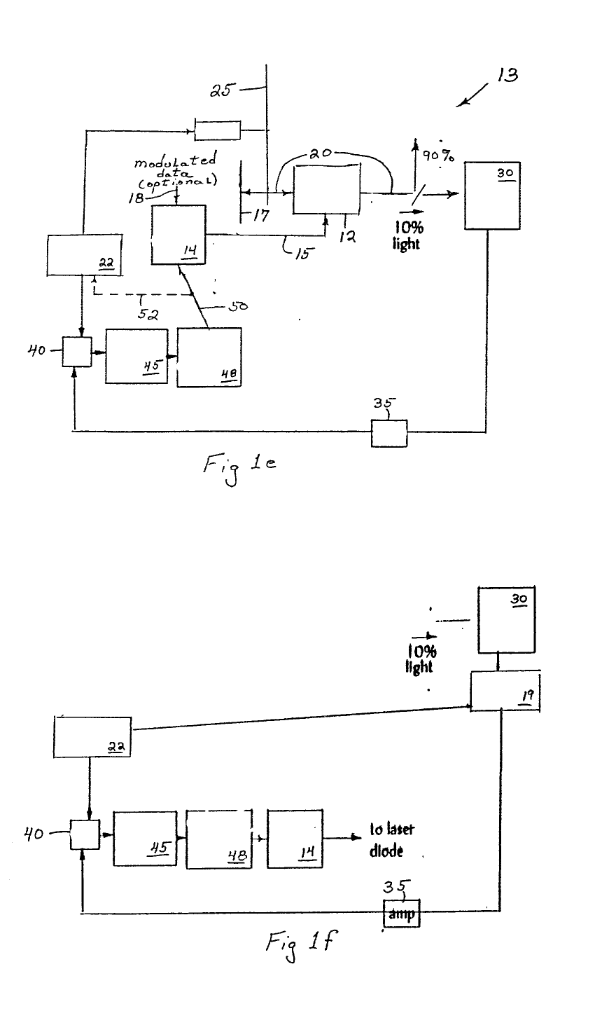

FIG. 1c illustrates a first embodiment of an NRZ to RZ conversion arrangement in a mode-locked laser 12 using a wavelength locked loop 13 as shown in FIG. 1e or 1f. This embodiment uses a disk shaped variable optical density filter wheel 25 having a plurality of different filter components, filter F1, filter F2, filter F3, . . . filter Fn circumferentially spaced therearound. Each filter component can comprise a multilayer dielectric film deposited on one surface of a silicon dioxide substrate (which is transparent to infrared wavelengths). Each filter component can pass a given bandwidth and have a bandpass center wavelength at which it passes the most light and generally define a Gaussian bandpass function. Alternatively, each filter component can have a continuously variable bandpass center wavelength which varies along the circumferential position or length of the filter component. Each filter component can be contiguous in wavelength to adjacent filter components or can be noncontiguous in wavelength to adjacent filter components.

The disk filter wheel 25 is driven to rotate about its central axis by a motor 16 drawn by a motor driver voltage 22, with the filter 25 being positioned in an external laser cavity having an anti-reflection coated Fabry-Perot laser diode 12 and an external cavity mirror 17 with diffraction grating rulings, which forms a frequency mode selective component as is known in the prior art. The disk filter 25 is positioned parallel to the external cavity mirror 17, and by rotating the disk filter the wavelength of the mode locked laser diode 12 may be selectively tuned. The wavelength can be tuned over the narrow bandwidth of each filter segment, and also over a wide bandwidth range of the 1 to n filter segments by selectively rotating and positioning each of the filter segments 1 to n relative to the laser diode 12.

FIG. 1d illustrates a plot of the motor drive voltage and the position of the filter wheel 25 with time as the motor 16 is driven to position the first filter F1 in series with the external laser cavity, and then position the second filter F2 in series with the external laser cavity, and then position the third filter F3 in series with the external laser cavity. As each filter segment is positioned in series with the external laser cavity, the wavelength of the laser is caused to oscillate about the bandpass center wavelength of that filter segment because of the dither wavelength locked loop explained hereinbelow, and this is illustrated by the sawtooth waveforms shown in FIG. 1c. The sawtooth waveforms are representative of one type of oscillating waveforms, and other types of oscillating waveforms, such as sinusoidal waveforms, could also be implemented herein.

This approach offers low loss, polarization independence, and the benefits of very precise control for the rotating filter which can be adjusted using proven optical disk drive technology, for example. However, the wavelength tunability of this mode-locked laser depends on alignment of the laser diode wavelength with the center wavelengths of the different filter segments of the filter wheel. In particular, fast tuning or wavelength modulation of the laser light requires the laser center wavelength to track the filter wheel response function over time as the wheel rotates on its axis.

Furthermore, it is desirable to include a position on the filter wheel for which the laser is able to operate in the NRZ mode, shown in FIG. 1c as NRZ mode, essentially removing the external cavity modulation by blocking light through the NRZ mode segment; such a device provides a single optical source capable of being quickly converted to run in either of the RZ or NRZ modes, thus allowing conversion between the two signaling formats.

The present invention utilizes a wavelength locked loop 13, as shown broadly in FIG. 1c and more specifically in FIGS. 1e and 1f, to provide this capability. There are many possible ways to implement a wavelength locked loop.

The waveform of FIG. 1d illustrates the operation of a first embodiment of an NRZ control loop wherein the filter wheel is controlled to spin with a rotational oscillatory dither about one of several center wavelength nominal positions, and the resulting loop feedback is used to adjust the laser bias point by feedback signal 50 or to adjust the filter wheel rotation speed by feedback signal 52, shown in phantom in FIGS. 1c and 1e to indicate an alternative embodiment.

FIG. 1f illustrates a second embodiment of the present invention wherein the filter wheel is rotated at a relatively constant rotational velocity, and a sampling circuit 19 is implemented as part of the wavelength locked loop to sample the light intensity whenever the filter wheel passes a given circumferential point; optional control circuitry can slave the sampling instant to the rotational speed of the disk. The sampled light intensity can then be used to control the wavelength locked control loop in a normal manner.

The present invention uses a wavelength locked control loop to allow greater precision in tuning the wavelength of a mode locked laser diode, or/and adjusting the rotation speed of the filter wheel, providing the ability to dynamically adjust for variations in the filter disk rotation speed, or laser aging effects in the laser, or aging of any system component, or temperature variations. This level of control makes RZ modulation a more practical and lower cost alternative, as well as facilitating the use of mode locked lasers for RZ to NRZ conversions.

In an alternative embodiment, the feedback signal from the wavelength locked loop could be utilized to control the temperature of the laser diode by a thermocouple rather than the laser diode bias voltage, to control the laser wavelength.

Digital representations of baseband signals commonly take the form of an amplitude modulated pulse train. For example, such signals can be expressed in the form

x(t)=sum for all k{akp(t−kD)}

where a k is the modulation amplitude for the kth symbol in the signal (amplitudes are commonly taken from a set of discrete values; for the case of binary signaling there are only 2 discrete values for the amplitude). The unmodulated waveform is given by p(t), where the discrete time signal is indexed by a step size of D. The value of D may be taken as the pulse duration, or more accurately as the pulse-to-pulse interval or the time allocated to one symbol in the message sequence. Thus, the signaling rate or baud rate is 1/D. This expression defines a digital pulse amplitude modulation scheme; the pulse p(t) which forms the basis of this scheme is most commonly rectangular in shape, subject to the condition

p(t)=1 if t=0, and 0 if t is a positive or negative multiple of D

This condition ensures recovery of the message by sampling x(t) periodically at intervals t=KD, where K is a positive or negative integer, or K is zero. This is true because

x(kD)=sum for all k{akp(KD−kD)}=ak

FIG. 1a represents each 0 by an off pulse (a k=0) and each 1 by an on pulse (with amplitude a k=A) and duration D/2, followed by a return to the zero level, in a return to zero (RZ) format.

The building blocks shown in FIGS. 1c-1f represent commercially available parts which may be assembled as described to implement the NRZ to RZ conversion methodology.

The wavelength-locked loop (WLL) is now described in further detail with reference to FIGS. 1-9. The basic operating principle of the wavelength-locked loop (WL) is described in greater detail in commonly-owned, co-pending U.S. patent application Ser. No. 09/865,256, entitled APPARATUS AND METHOD FOR WAVELENGTH-LOCKED LOOPS FOR SYSTEMS AND APPLICATIONS EMPLOYING ELECTROMAGNETIC SIGNALS, the whole contents and disclosure of which is incorporated by reference as if fully set forth herein.

FIGS. 1c, 1e and 1f depict exemplary optical systems including a light source such as laser diode 12 driven with both a bias voltage 15 from a voltage bias circuit 14 and modulated data 18 from a data source (not shown). The laser diode generates an optical (laser light) signal 20 that is received by a disk shaped bandpass filter 25, or any frequency selective device including but not limited to: thin film optical interference filters, acousto-optic filters, electro-optic filters, diffraction gratings, prisms, fiber Bragg gratings, integrated optics interferometers, electroabsorption filters, and liquid crystals. The laser diode itself may comprise a standard Fabry Perot or any other type (e.g., Vertical Cavity Surface Emitting (VCSEL)), light emitting diodes, or, may comprise a Distributed Feedback semiconductor laser diode (DFB) such as commonly used for wavelength multiplexing. Preferably, the laser diode emits light in the range of 850 nm to 1550 nm wavelength range. As mentioned, the bandpass filter may comprise a thin film interference filter comprising multiple layers of alternating refractive indices on a transparent substrate, e.g., glass.

As further shown in FIG. 1c, according to the invention, a motor drive 22 generates an oscillating dither modulation signal 27 that modulates the position of the disk filter to cause a corresponding dither in the laser center wavelength. A beam splitter B/S taps off a small amount of light, for example, which is directed to the control loop 13, FIGS. 1e, 1f and is incident upon a photo detector receiver device, e.g., PIN diode 30, and converted into an electrical feedback signal 32. The amount of light that may be tapped off may range anywhere between one percent (1%) to ten percent (10%) of the optical output signal, for example, however, skilled artisans will appreciate any amount of laser light above the noise level that retains the integrity of the output signal including the dither modulation characteristic, may be tapped off. The remaining laser light (e.g. 90-99%) passes to the optical network (not shown). As the PIN diode output 32 is a relatively weak electric signal, the resultant feedback signal is amplified by amplifier device 35 to boost the signal strength. The amplified electric feedback signal is input to a multiplier device 40 where it is combined with the original dither modulation signal 27. The cross product signal 42 that results from the multiplication of the amplified PIN diode output (feedback signal) and the dither signal 27 includes terms at the sum and difference of the dither frequencies. The result is thus input to a low pass filter device 45 where it is low pass filtered and then averaged by integrator circuit 48 to produce an error feedback signal 50 which is positive or negative depending on whether the laser center wavelength is respectively less than or greater than the center point of the bandpass filter. The error signal 50 is input to the voltage bias control 14. In this manner, the laser wavelength will increase or decrease until it exactly matches the center of the filter passband. Alternately, the error feedback signal 50 may be first converted to a digital form prior to input to the wavelength control 14.

According to one aspect of the invention, the WLL will automatically maintain tracking of the laser center wavelength to the peak of the optical filter. However, in some cases, it may not be desirable to enable laser alignment to the filter peak, e.g., in an optical attenuator. Thus, as shown in the embodiment depicted in FIG. 8, there is provided an optional external tuning circuit, herein referred to as a wavelength shifter device 51, that receives the error signal and varies or offsets it so that the laser center wavelength may be shifted or offset in a predetermined manner according to a particular network application. That is, the wavelength shifter 51 allows some external input, e.g., a manual control element such as a knob, to introduce an arbitrary, fixed offset between the laser center wavelength and the filter peak.

A generalized description of how dithering is implemented for providing a WLL in the present invention is now provided in view of FIG. 7. As shown in FIG. 7, the dither generator (harmonic oscillator) 22 produces a dither signal 27, I which causes the laser center wavelength to oscillate with a small amplitude about its nominal position. After passing thru the optical bandpass filter, the laser wavelength variation is converted into intensity variation which is detected by the photodetector circuit 30 (e.g., photodiode). The servo loop feeds back the photodiode output signal, S, and takes a vector cross product with the original sinusoidal dither signal 27, I. The cross product result is averaged (integrated) over a time period T and may be sampled and digitized to produce the equivalent of an error detect signal, R, which is bipolar and proportional to the amount by which the laser center wavelength and filter center wavelength are misaligned. Optionally, the signals may be normalized to account for variations in the laser power output from the filter. Optionally, an external tuning circuit may be implemented to receive the error signal and enable the laser center wavelength offset to vary to an arbitrary value. Finally, the error signal R is fed back used by the wavelength control 14 to adjust the laser center wavelength in the proper direction to better align with the filter center wavelength.

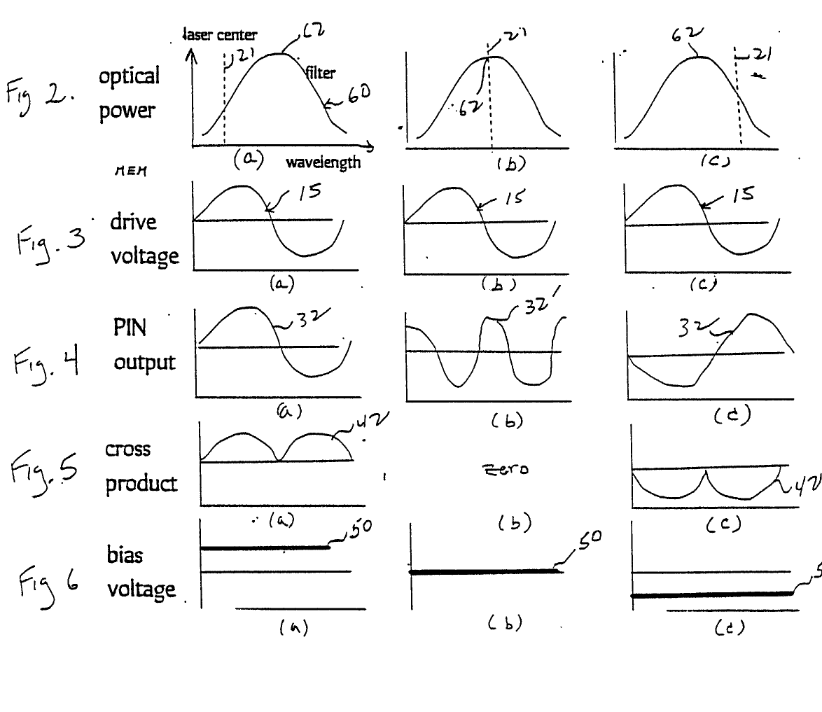

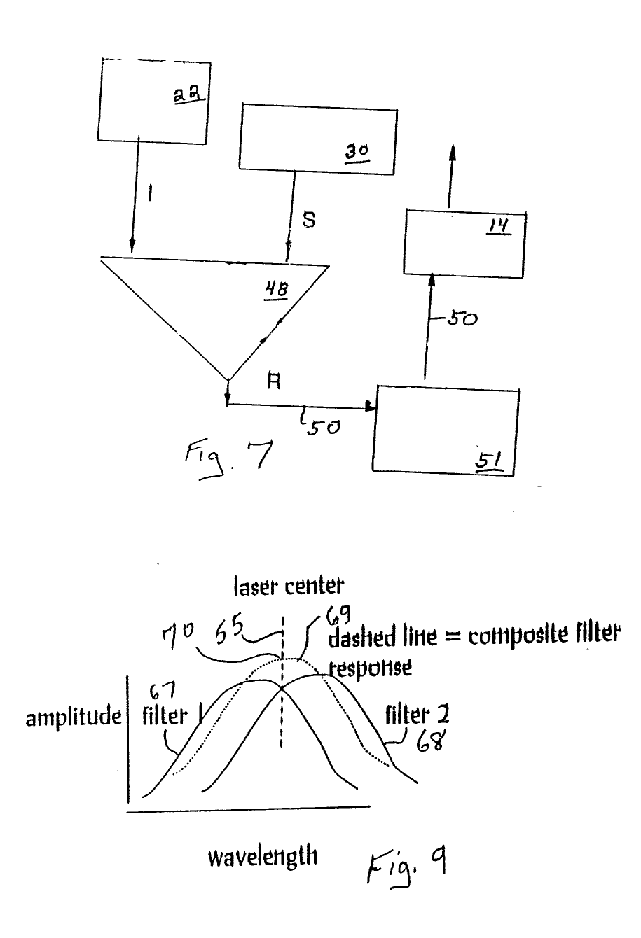

The operating principle is further illustrated in the timing and signal diagrams of FIGS. 2-6. FIGS. 2(a)-2(c) particularly depicts the relationship between laser optical power as a function of wavelength for three instances of optic laser signals: a first instance (FIG. 2(a)) where the laser signal frequency center point 21 is less than the bandpass function centerpoint as indicated by the filter bandpass function 60 having centerpoint 62 as shown superimposed in the figures; a second instance (FIG. 2(b)) where the laser frequency center point 21 is aligned with the bandpass function centerpoint 62; and, a third instance (FIG. 2(c)) where the laser frequency center point 21 is greater than the bandpass function centerpoint 62. In each instance, as depicted in corresponding FIGS. 3(a)-3(c), the drive voltage signal 15 is shown dithered (a sinusoid) resulting in the laser wavelength dithering in the same manner. The dithered laser diode spectra passes through the filter, and is converted to electrical form by the PIN diode 30. In each instance of the laser signals depicted in FIGS. 2(a) and 2(c) having frequency centerpoints respectively less than and greater than the band pass filter centerpoint, it is the case that the dither harmonic spectra does not pass through the frequency peak or centerpoint of the bandpass filter. Consequently, the resulting output of the PIN diode is an electric sinusoidal signal of the same frequency as the dither frequency such as depicted in corresponding FIGS. 4(a) and 4(c). It is noted that for the laser signals at frequencies below the peak (FIG. 2(a)) the feedback error signal 32 corresponds in frequency and phase to the dither signal (FIG. 4(a)), however for the laser signals at frequencies above the peak (FIG. 2(c)) the feedback error signal 32 corresponds in frequency but is 180° opposite phase of the dither signal (FIG. 4(c)). Due to the bipolar nature of the feedback signal (error signal) for cases when the laser signal centerpoint is misaligned with the bandpass filter centerpoint, it is thus known in what direction to drive the laser wavelength (magnitude and direction), which phenomena may be exploited in many different applications. For the laser signal depicted in FIG. 2(b) having the laser frequency center point aligned with the bandpass function centerpoint, the dither harmonic spectra is aligned with and passes through the frequency peak (maximum) of the bandpass filter twice. That is, during one cycle (a complete round trip of the sinusoid dither signal), the dither signal passes though the centerpoint twice. This results in a frequency doubling of the dither frequency of the feedback signal 32, i.e., a unique frequency doubling signature, as depicted as PIN diode output 32′ in FIG. 4(b) showing a feedback error signal at twice the frequency of the dither frequency.

Thus, in each instance, as depicted in corresponding FIG. 4(b), the resulting feedback signal exhibits frequency doubling if the laser center wavelength is aligned with the filter center wavelength; otherwise it generates a signal with the same dither frequency, which is either in phase (FIG. 4(a)) or out of phase (FIG. 4(c)) with the original dither modulation. It should be understood that, for the case where the laser center frequency is misaligned with the bandpass filter peak and yet there is exhibited partial overlap of the dither spectra through the bandpass filter peak (i.e., the centerpoint peak is traversed twice in a dither cycle), the PIN diode will detect partial frequency doubling at opposite phases depending upon whether the laser center frequency is inboard or outboard of the filter center frequency. Thus, even though partial frequency doubling is detected, it may still be detected from the feedback signal in which direction and magnitude the laser signal should be driven for alignment.

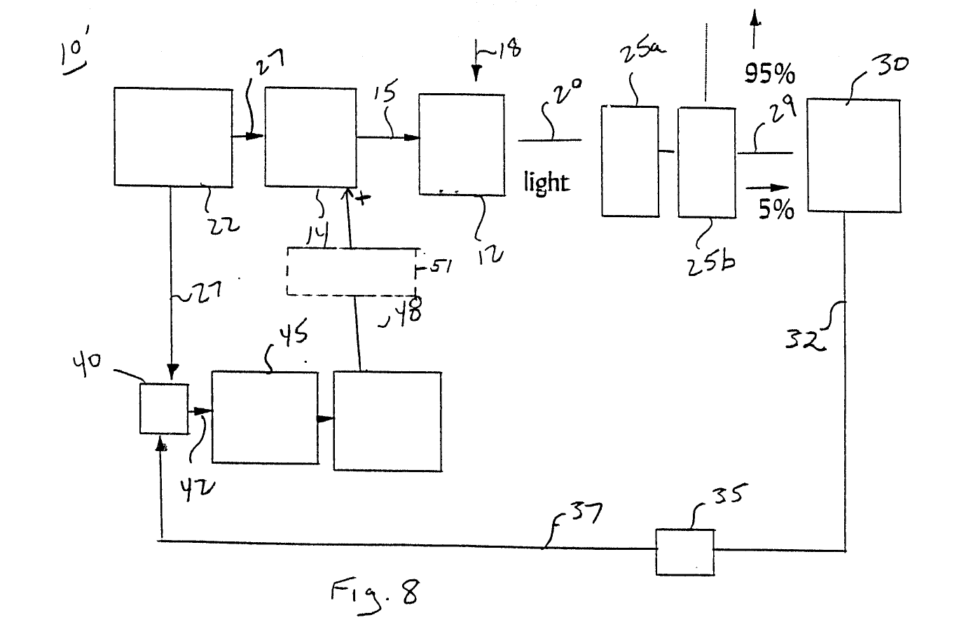

Thus, referring now to FIGS. 5(a) and 5(c), for the case when the laser and filter are not aligned, the cross product signal 42 resulting from the mixing of the amplified feedback error with the original dither sinusoid is a signed error signal either at a first polarity (for the laser signals at frequencies below the bandpass filter centerpoint), such as shown in FIG. 5(a) or, at a second polarity (for the laser signals at frequencies above the bandpass filter centerpoint), such as shown in FIG. 5(c). Each of these signals may be rectified and converted into a digital output laser bias voltage signal 48 as shown in respective FIGS. 6(a) and 6(c), which are fed back to respectively increase or decrease the laser current (wavelength) in such a way that the laser center wavelength moves closer to the bandpass filter centerpoint. For the case when the laser and filter are aligned, the cross product generated is the frequency doubled signal (twice the frequency of the dither) as shown in the figures. Consequently, this results in a 0 V dc bias voltage (FIG. 6(b)) which will maintain the laser frequency centerpoint at its current wavelength value.

In order to describe further benefits of the invention, it is first noted that although it may appear that if a filter bandpass is larger than the laser linewidth, then the entire optical pulse will pass through the filter unaffected. However, this is clearly not the case; the laser spectra and filter function are both Gaussian, in both time and frequency. Thus, passing the laser spectra through the filter results in a convolution between the spectrum and filter functions. Implementing analog signal processing, an output optical spectrum is produced which is actually narrower than the input spectra (i.e., some of the light is lost during filtering). In a real WDM system there may be at least two (2) bandpass filter devices in a link to perform multiplex/demux functions at either end: in practice, there may be many bandpass filters configured in series. This leads to a secondary problem: when two filters are in series and their bandpass centers are not aligned, the original signal must be convolved with both filter functions; this narrows the signal spectra even further, at the cost of lowering the optical power by discarding the edges of the light spectra. A succession of filters not aligned with each other can be shown to have the same characteristics as a single, much narrower, filter. This further reduces the margin for misalignment between the laser and multiple filters. For example, even if the ideal center to center, wavelength spacing of a WDM system is 0.8 nm, due to misalignment between the mux and demux filters this window may be reduced to approximately 0.4 nm or less. This would require extreme precision and stability for the laser wavelength, making for a very expensive laser transmitter. Thus, there are really two problems to be solved: (1) laser to filter alignment; and, (2) filter to filter alignment. Note that when signals propagate through a fiber optic network and traverse multiple filters the wavelength may shift due to these effects combined with temperature and environmental effects. It is a real, practical problem to keep an input wavelength the same throughout the network, so that network architectures such as ring mesh, wavelength reuse, and wavelength conversion may work properly, i.e., this is called frequency referencing.

The present invention addresses frequency referencing as it can handle both of these instances. For example, as shown in FIG. 8, there is depicted a general block diagram depicting the underlying system architecture employing the wavelength-locked loop technique in an optical system 10′ employing a series connection of two bandpass filters 25a, 25b.

FIG. 9 depicts each of the individual filter responses 67 and 68 for the two bandpass filters 25a, 25b of FIG. 8 and the corresponding composite filter response 69 having a centerpoint or peak 70. When performing filter to filter or multiple filter alignment, the technique of the invention depicted in FIG. 8 may be implemented to tune the laser signal 55 to have a center frequency such that maximum power transfer will occur through the series connection of two bandpass filters as represented by its composite filter response 69 (FIG. 9). Generally, a cascade of bandpass filters results in an effective narrowing of the overall passband, as the net filter response is a convolution of the component filter responses. The WLL can align the laser center wavelength with the middle of this composite passband.

The system and method of the present invention may be used to tune a laser wavelength to compensate for any type of wavelength-selective element in a network, including wavelength selective switches, tunable filters, in fiber Bragg gratings, ring resonators in optical amplifiers, external modulators such as acousto-optic tunable filters, or array waveguide gratings. This applies to many other optical components in the network as well (for example, optical amplifiers that can act as filters when operating in the nonlinear regime). This method may additionally be used to implement less expensive devices for all of the above application areas. As the optical loss of a WDM filter/laser combination is greatly reduced by implementing the technique of the invention, significantly larger link budgets and longer distances may be supported. Further, the invention permits much lower cost lasers and filters to be used; since these are the most expensive parts of a WDM device today, there is a significant cost reduction in the WDM equipment.

While several embodiments and variations of the present invention for an NRZ to RZ conversion in mode-locked lasers using wavelength locked loops are described in detail herein, it should be apparent that the disclosure and teachings of the present invention will suggest many alternative designs to those skilled in the art.

Having thus described our invention, what we claim as new and desire to secure by Letters Patents is:

1. An arrangement for converting a nonreturn-to-zero (NRZ) signal format to a return-to-zero (RZ) signal format comprising:
a variable optical filter having a plurality of different filter segments for different wavelengths spaced circumferentially about a central rotational axis, about which the filter is rotated;
a drive motor for rotationally driving and positioning the variable optical filter;
a laser for generating a laser beam, with the variable optical filter being positioned relative to the laser to filter the generated laser beam, such that the variable optical filter can be rotationally positioned to selectively tune the wavelength of the laser;
a wavelength locked feedback loop for dynamically adjusting the wavelength of the laser beam to maintain the laser beam wavelength nominally centered at a desired wavelength as determined by the rotational position of the variable optical filter.

2. The arrangement of claim 1, wherein the variable optical filter is positioned external to the laser cavity to form an external cavity frequency modulator of the laser beam and to mode lock the laser, and each filter segment is positioned in series with the external laser cavity to selectively tune the wavelength of the laser beam.

3. The arrangement of claim 2, wherein the variable optical filter defines an NRZ mode segment at which the laser operates in the NRZ mode, removing the external cavity modulation by blocking light through the NRZ mode segment, such that the arrangement can be converted to run in either of the RZ or NRZ modes, thus allowing conversion between the two signal formats.

4. The arrangement of claim 1, wherein the wavelength locked feedback loop dynamically adjusts the wavelength of the laser to maintain the laser beam wavelength nominally centered at the desired wavelength as determined by the rotational position of the variable optical filter.

5. The arrangement of claim 1, wherein the wavelength locked loop dynamically adjusts the drive signal of the drive motor to maintain the laser beam wavelength nominally centered at a desired wavelength as determined by the rotational position of the variable optical filter.

6. The arrangement of claim 1, wherein each filter segment passes a given bandwidth and has a bandpass center wavelength at which it passes the most light and generally defines a Gaussian bandpass function.

7. The arrangement of claim 1, wherein each filter segment has a continuously variable bandpass center wavelength which varies along and with the circumferential position of the filter segment.

8. The arrangement of claim 1, wherein each filter segment comprises a multilayer dielectric film deposited on one surface of a filter substrate.

9. The arrangement of claim 1, for converting signals between a communication network using a nonreturn-to-zero (NRZ) signal format and a soliton-based optical communication system using a return-to-zero (RZ) signal format.

10. The arrangement of claim 1, wherein the variable optical filter comprises a disk shaped variable density filter having a plurality of different filter segments, filter 1 to filter n, circumferentially spaced therearound, such that the wavelength of the laser beam can be tuned over the narrow bandwidth of each filter segment, and also over a wide bandwidth range of the 1 to n filter segments by selectively rotating and positioning each of the filter segments 1 to n relative to the laser beam.

11. The arrangement of claim 1, wherein the filter is in an external laser cavity with the laser and an external cavity mirror with diffraction grating rulings, the filter is positioned parallel to the external cavity mirror, and by selectively rotating the variable optical filter, the wavelength of the laser beam is selectively tuned.

12. The arrangement of claim 1, wherein the laser is an anti-reflection coated Fabry-Perot laser diode.

13. The arrangement of claim 1, including:
a dither generator for generating a dither signal which is applied to the drive motor, wherein the position of the variable optical filter oscillates at a dither frequency about a nominal angular position which produces a periodic change in the laser output wavelength;
a detector detects the laser output, and the detector output is proportional to the dither modulation of the intensity of the laser output which is produced when the dithered laser output passes through the variable optical filter;
the detector output is mixed with the dither signal to produce a vector cross product feedback signal which indicates whether the laser wavelength is aligned with the filter center wavelength, and if not in what direction and by what amount the wavelength of the laser beam must be shifted to be brought into alignment with the filter center wavelength.

14. The arrangement of claim 1, wherein the variable optical filter is rotated at a relatively constant rotational velocity, and the wavelength locked loop includes a sampling circuit to sample the light intensity of the laser beam whenever the filter passes a given circumferential point.

15. The arrangement of claim 1, wherein the variable filter optical is controlled to spin with a rotational oscillatory dither about one of several center wavelength nominal positions, and the wavelength locked feedback loop adjusts the laser voltage bias point.
